(19) United States
(12) Patent Application Publication
(10) Pub. No.: US 2026/0260131 A1
(43) Pub. Date: Sep. 3, 2026

(54) Co-Browsing System for Online Interactions Amongst Artificial Intelligence and Human Users

(71) Applicant: Samesurf, Inc., Los Angeles, CA (US)

(72) Inventor: Kambiz David Pirnazar, Los Angeles, CA (US)

(21) Appl. No.: 19/661,352

(22) Filed: Apr. 28, 2026

Related U.S. Application Data
(63) Continuation of application No. 18/649,914, filed on Apr. 29, 2024.
(63) Continuation-in-part of application No. 18/790,471, filed on Jul. 31, 2024.
Application No. 18/790,471 is a continuation of application No. 18/370,331, filed on Sep. 19, 2023, now Pat. No. 12,088,647.
Application No. 18/370,331 is a continuation of application No. 18/225,982, filed on Jul. 25, 2023, now Pat. No. 12,101,361.
(60) Provisional application No. 63/446,707, filed on Feb. 17, 2023.
(60) Provisional application No. 63/448,057, filed on Feb. 24, 2023.
(60) Provisional application No. 63/463,395, filed on May 2, 2023.

(51) Int. Cl. G06N 5/01; G06F 9/451

(52) U.S. Cl. CPC G06N 5/01; G06F 9/453

(57) ABSTRACT

There is provided a method including instantiating a first AI controlled agent, receiving a request from a human user device or a second AI controlled agent, predicting, using a trained ML model, a goal corresponding to the request, identifying a URL for advancing the goal, initiating, using the first AI controlled agent and the URL, a simulated browsing session, autonomously determining, using the first AI controlled agent, an online action for advancing the goal, selecting, using the first AI controlled agent based on the online action, one or both of the cloud browser or the API for executing the online action, executing the online action, using the one or both of the cloud browser or the API selected for executing the online action, to generate a result for advancing the goal, and communicating, to the human user device or the second AI controlled agent, the result for advancing the goal.

### RELATED APPLICATIONS

The present application is a continuation of U.S. patent application Ser. No. 18/649,914, filed Apr. 29, 2024, which claims the benefit of and priority to pending Provisional Patent Application Ser. No. 63/463,395, filed May 2, 2023, and titled “Synchronized Browsing System for Interactions Between AI agents and Humans,” which is hereby incorporated fully by reference into the present application.

### BACKGROUND

Within remote online interactions for use cases such as assisted sales, online support, virtual onboarding, telemedicine, and other interactions that commonly take place between human users and virtual agents, current functionalities for communication are limited to spoken audio and text-based exchanges that lack visually oriented co-browsing capabilities that would necessarily complement these interactions. Current offerings typically utilize (a) simple text-based exchanges and/or (b) speech-to-text based conversion constructs that detect human language, and which then convert letters, words, symbols, images and other inputs into readable forms of text-based language. As such, conventional scripted agent, machine learning and artificial intelligence technologies do not currently provide fully interactive, real-time visual co-browsing mechanisms that match or complement the underlying interactions and/or conversations that are occurring in real time between agents that are powered by artificial intelligence (“AI”) and/or human users. The lack of a fully interactive, visually oriented co-browse system that accompanies text, speech and/or other communicative based interactions invariably leads to failures in providing instantly actionable and visual frameworks for these types of interactions in a manner that would necessarily improve clarity, knowledge retention and effectiveness. Within this realm, conventional virtual agent, robot and/or “bot” systems do not provide a fully interactive system or modality-such as synchronized browsing or “co-browsing”-that would convert remote interactions between artificial intelligence agents and human users into an instantly actionable framework for exemplary use cases such as visually enhanced communication, sales, support, commerce, healthcare, entertainment and/or other formats for remote online interactions that occur in real time.

### BRIEF DESCRIPTION OF THE DRAWINGS

FIG. 1 shows an exemplary system that provides synchronized browsing or co-browsing for remote interactions amongst artificial intelligence (“AI”) agents and humans, according to one implementation;

FIG. 2 shows an exemplary screenshot from a co-browsing session, according to one implementation;

FIG. 3 shows an unredacted co-browsing page that is provided to a human user and a redacted co-browsing page that is provided to an AI agent during a co-browsing session, according to one implementation;

FIG. 4 shows an exemplary screenshot from a co-browsing session, according to another implementation; and

FIG. 5 shows a flowchart presenting an exemplary method for use by a system to provide co-browsing for remote interactions amongst AI agents and humans, according to one implementation.

### DETAILED DESCRIPTION

The following description contains specific information pertaining to implementations in the present disclosure. One skilled in the art will recognize that the present disclosure may be implemented in a manner that is different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

The present application discloses integrating co-browse and/or synchronized browsing functionality with scripted, machine learning and/or artificial intelligence (“AI”) technology. This application presents a parallel co-browsing system that synchronously simulates the underlying exchanges that are occurring between one or more AI agents (hereinafter “AI agent(s)”) and one or more human users (hereinafter “user(s)”) within a highly visual, fully interactive and multi-user system that provides an instantly actionable framework for real time interaction within, among or pertaining to the presented online content.

For purposes of the present application, the terms “synchronized browsing” and/or “co-browsing” include all forms of synchronized browsing, collaborative browsing and/or shared browsing which include, but are not limited to:
(1) “event driven” HTML co-browsing systems where web browsing interactions that are occurring on the host side are detected and transmitted by the synchronization server for replication by the guest device via direct and continuous access to the relevant website server;
(2) cloud based synchronized browsing systems where the web browsing interactions of one or more host devices are taking place within the confines of a “cloud browser” that transmits the result of those web browsing interactions to the guest devices in real-time for co-browsing and/or in-page control passing by all participants; and/or
(3) any other synchronized browsing or co-browsing constructs that currently or in the future may exist for any and all devices, apps (mobile and desktop), metaverses, 3D (three-dimensional) experience software or hardware formats (such as the Meta Oculus®), websites and/or other forms of content.

The synchronized browsing system that provides co-browsing sessions for interactions amongst AI agents and human users disclosed in the present application may also integrate the following complementary and exemplary systems to provide a visually realistic, ultra-secure and fully interactive context for online interactions amongst AI agent(s) and human(s):
(1) Voice replication systems;
(2) Avatar generation technologies;
(3) Facial gesturing solutions for detecting, rendering and/or simulating conversations in real time;
(4) Voice recognition and biometric identification technology for user authentication and other purposes; and
(5) Screen redaction technology for safeguarding sensitive data in order to achieve ultra-secure and fully compliant interactions that meet or exceed regulatory regimes such as GDPR (General Data Protection Regulation®), PCI-DSS (Payment Card Industry Data Security Standard®) and HIPAA (Health Insurance Portability and Accountability Act®).

It is noted that the synchronized browsing system for interactions amongst AI agent and human users disclosed in the present application advances the state-of-the-art in numerous significant ways. Some of these exemplary improvements are described below:

Conventional AI systems do not provide a fully interactive modality such as synchronized browsing or co-browsing, which enables an AI agent and a human user to pass navigational control of a co-browsing session within the same web content which enables the human user:
a) to assume (or share) navigational control of the featured online content or web browsing journey from (or with) the AI agent at any point within the shared online interactions and/or browsing journey; and/or
b) to perform exemplary online actions within a shared browsing experience such as completing presented online forms or transactions and/or assuming navigational leadership control within an active session that includes text-based language and Uniform Resource Locator (URL) suggestions from the AI agent.

It is contemplated that the installment of co-browsing technology within conversational human-agent interactions will provide commensurate and synchronous visual context that will lead to significant improvements in important key performance indicators (KPIs) for remote online interactions of all kinds. These exemplary improvements in KPIs would stem from: (i) overall user effectiveness and satisfaction; (ii) knowledge retention; (iii) multi-user interactivity; (iv) conversion rates; (v) transaction volumes; (vi) customer support times; and (vii) deeper levels of learning.

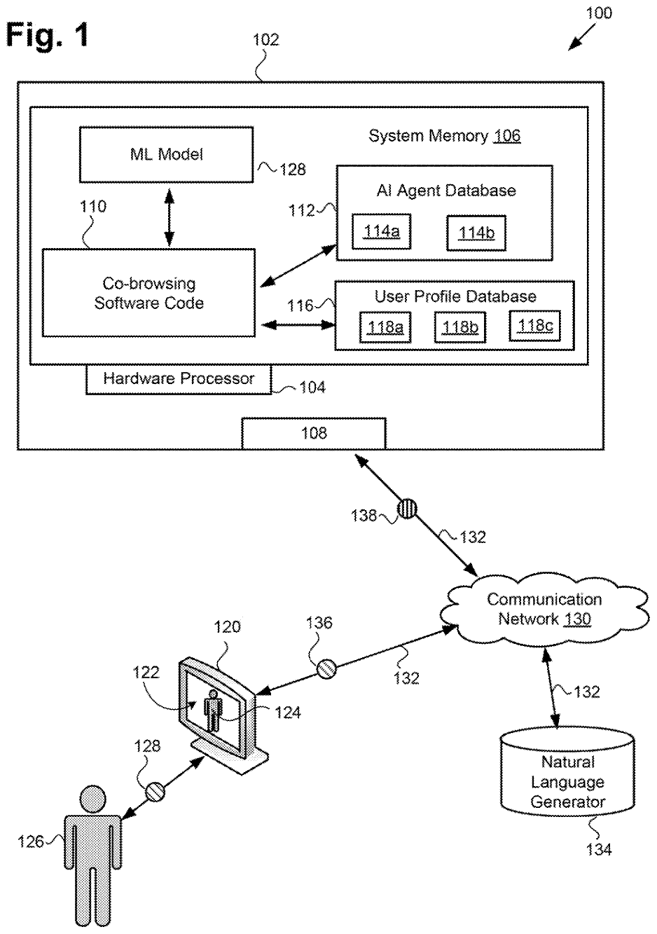

FIG. 1 shows a diagram of exemplary system 100 providing synchronized browsing within online interactions amongst AI agents and humans, according to one implementation. As shown in FIG. 1, system 100 includes computing platform 102 having hardware processor 104, transceiver 108, and system memory 106 implemented as a non-transitory storage medium. According to the present exemplary implementation, system memory 106 stores co-browsing software code 110, AI agent database 112 including AI personas 114a and 114b, user profile database 116 including co-browsing histories 118a, 118b and 118c, and ML model 128 trained to classify user requests.

As further shown in FIG. 1, system 100 is implemented within a use environment including (1) communication network 130 providing network communication links 132; (2) Natural Language Generator (NLG) 134, which may be or include a large-language ML model for example, communicatively coupled to system 100 via communication network 130 and (3) network communication links 132. Also shown in FIG. 1 are (1) human user 126 (hereinafter “user 126”) utilizing user system 120 to interact with system 100 via communication network 130; (2) AI agent 124 instantiated by system 100 and rendered on display 122 of user system 100; (3) user request 136; and (4) unredacted co-browsing page 138 which is provided to user 126 by system 100.

As defined in the present application, it is noted that the expression “ML model” refers to a computational model for making future predictions based on patterns learned from samples of data or “training data.” Various learning algorithms can be used to map correlations between input data and output data. These correlations form the computational model that can be used to make future predictions on new input data. By way of example, a predictive model of this type may include one or more logistic regression models, Bayesian models, or artificial neural networks (NNs). Moreover and in the context of deep learning, a “deep neural network” may refer to an NN that utilizes multiple hidden layers between input and output layers, which may allow for learning based on features that are not explicitly defined in raw data. As used in the present application, any feature identified as an NN refers to a deep neural network.

It is further noted that although FIG. 1 depicts AI agent 124 as being instantiated as a digital character rendered on display 122, that representation is provided merely by way of example. In other implementations, AI agent 124 may be instantiated by exemplary devices such as audio speakers, displays, virtual headsets, figurines, or by wall mounted audio speakers or displays.

Furthermore and although FIG. 1 depicts one user 126 and one AI agent 124, that representation is also merely exemplary. In other implementations, one AI agent, two AI agents, or more than two AI agents may engage in a co-browsing session with one or more human beings or users corresponding to user 126. It is also noted that although FIG. 1 depicts two personas 114a and 114b and three co-browsing histories 118a, 118b and 118c, AI agent database 112 will typically store tens or hundreds of personas, while user profile database 116 will typically store hundreds or thousands of co-browsing histories.

Moreover, it is noted that each of co-browsing histories 118a, 118b and 118c may be a co-browsing history dedicated to cumulative interactions of an AI agent or agents with the same person, such as user 126, or to one or more distinct temporal sessions over which an interaction of one or more AI agents and user 126 extends. Furthermore and while in some implementations a co-browsing history stored in user profile database 116 may be comprehensive with respect to interactions by a user with AI agent 124, a co-browsing history stored in user profile database 116 may retain only a predetermined number of the most recent interactions by a user with AI agent 124 in other implementations.

Although the present application refers to co-browsing software code 110, AI agent database 112, user profile database 116, and ML model 128 as being stored in system memory 106 for conceptual clarity, system memory 106 may more generally take the form of any computer-readable non-transitory storage medium. The expression, “computer-readable non-transitory storage medium” as defined in the present application, refers to any medium, excluding a carrier wave or other transitory signal that provides instructions to hardware processor 104 of computing platform 102. Thus, a computer-readable non-transitory medium may correspond to various types of exemplary media, such as volatile media and non-volatile media. Volatile media may include dynamic memory, such as dynamic random access memory (dynamic RAM), while non-volatile memory may include optical, magnetic, or electrostatic storage devices. Common forms of computer-readable non-transitory storage media include examples such as optical discs, RAM, programmable read-only memory (PROM), erasable PROM (EPROM), and FLASH memory.

It is further noted that although FIG. 1 depicts co-browsing software code 110, AI agent database 112, user profile database 116, and ML model 128 as being co-located in system memory 106, that representation is also merely provided as an aid to conceptual clarity. In a more general sense, system 100 may include one or more computing platforms 102, such as computer servers which may be co-located, or may form an interactively linked but distributed system, such as a cloud based system. As a result, hardware processor 104 and system memory 106 may correspond to distributed processor and memory resources within system 100. Consequently and in some implementations, co-browsing software code 110, AI agent database 112, user profile database 116, and ML model 128 may be stored remotely from one another on the distributed memory resources of system 100. Furthermore and although FIG. 1 depicts NLG 134 as being a remote resource accessible by system 100 using communication network 130, NLG 134 may be a component of system 100 and may be stored within the memory resources of system 100 in some implementations.

Hardware processor 104 may include multiple and exemplary hardware processing units such as one or more central processing units, one or more graphics processing units, one or more tensor processing units, one or more field-programmable gate arrays (FPGAs), custom hardware for machine-learning training or inferencing, and an application programming interface (API) server. By way of definition and as used in the present application, the terms “central processing unit” (CPU), “graphics processing unit” (GPU), and “tensor processing unit” (TPU) have their customary meaning in the art. Accordingly, a CPU includes an Arithmetic Logic Unit (ALU) for carrying out the arithmetic and logical operations of computing platform 102, as well as a Control Unit (CU) for retrieving programs, such as co-browsing software code 110, from system memory 106. Within this realm, a GPU may be implemented to reduce the processing overhead of the CPU by performing computationally intensive graphics or other processing tasks. A TPU is an application-specific integrated circuit (ASIC) that is configured specifically for AI applications such as machine learning modeling.

In some implementations, computing platform 102 may correspond to one or more web servers which are accessible over a packet-switched network such as the Internet, for example. Alternatively, computing platform 102 may correspond to one or more computer servers supporting a private wide area network (WAN), local area network (LAN), or one that is included in another type of limited distribution or private network. As an alternative and in some implementations, system 100 may utilize exemplary local area broadcast methods such as User Datagram Protocol (UDP) or Bluetooth. Furthermore and in some implementations, system 100 may be implemented virtually, such as in a data center. For example and in some implementations, system 100 may be implemented in software, or as virtual machines. Moreover and in some implementations, communication network 130 may be a high-speed network that is suitable for high performance computing (HPC)-for example, a 10 GigE network or an Infiniband network.

Transceiver 108 may be implemented as a wireless communication unit configured for use with one or more of a variety of wireless communication protocols. For example, transceiver 108 may include a fourth generation (4G) wireless transceiver and/or a 5G wireless transceiver. In addition and as an alternative, transceiver 108 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

User system 120 may take the form of a desktop computer, or any other suitable mobile or stationary computing system that implements data processing capabilities that are sufficient to provide a user interface, and implement the functionality attributed to user system 120 herein. For example and in other implementations, user system 120 may take the form of a laptop computer, tablet computer, smartphone (browser-based or native mobile application), or any augmented reality (AR) or virtual reality (VR) device, for example, providing display 122. Display 122 may be or include a liquid crystal display (LCD), a light-emitting diode (LED) display, an organic light-emitting diode (OLED) display, a quantum dot (QD) display, or any other suitable display screen that performs a physical transformation of signals to light.

For purposes of the present application, it is noted that the described constructs apply to interactions by AI agents with at least one other user that are text based, spoken word, or that take place within other communicative forms such as within three dimensional (3D) virtual environments. Furthermore, the described constructs apply to interactions where AI agent 124 is either represented by an “avatar” or not represented by an “avatar.” For purposes of the present application, an “avatar” is defined as “a computer-based simulation, instantiation embodiment, or manifestation of a person or idea.”

It is further noted that for purposes of the present application, (1) some interactions may rely on human scripted or pre-programmed user-agent experience flows, the paths of which can be driven by the respective requests, such as queries, actions, decisions and/or responses from the user; whereas (2) other interactions may rely on past, current and/or future AI or machine learning technologies that may automatically present visual cues or certain forms of content based on the requests, such as queries, actions, inactions, decisions and responses that are presented to and by user 126 within each interaction.

Moreover, system 100 may be agnostic as to the type of AI, machine learning or scripted technology that is utilized. The subject AI, machine learning and/or scripted technology may simply be integrated into this fully interactive synchronized browsing system for purposes of answering questions, providing actionable (co-browse ready) visual cues and displaying relevant URL(s) and/or online interactions that match the underlying content of the AI agent-human conversations.

System 100 may leverage multiple technologies on the back-end, such as:
(1) Scripted Technology: In the exemplary event that a particular key phrase (or combination of key phrases) are presented by user 126, system 100 may display or share a particular set of URLs in order of priority based on input from user 126 while being able to simulate and perform scripted online browsing interactions such as page scrolling, element highlighting, form filling and any other form of online browsing interaction in real-time; and/or
(2) AI or Machine Learning: In the exemplary event that a particular key phrase (or combination of key phrases) are presented by user 126, the NLG 134 (ex: ChatGPT® or Google® Gemini) may be used to select the designations of the URL(s) and online browsing interactions to present, render and/or set up within the co-browsing session.

The back-end response technology can utilize AI/machine learning and/or human written, pre-programmed scripted elements for the presented navigational components. In other implementations, a combination of agent AI and/or machine learning and human driven script modalities can be used.

Furthermore, the back-end systems can be driven entirely by AI, machine learning, human written script and/or other forms of similar technologies. Accordingly, the application may provide a fully interactive synchronized co-browsing component that complements a human-agent interaction in order to add a highly visual, fully interactive element to the online interaction, which may simulate the experience of having all users (agents and humans) in the same room at the same time despite their remote geographical proximities to one another.

In one implementation, system 100 can convert voice, text, symbols and audio inputs into commensurately displayed URL and/or online browsing interaction prompts, commands, displays and other instructions on the back-end to take the user through a scripted or AI driven online experience journey based upon the actions, questions or responses that are received from user 126. One key for adding the fully interactive, visually oriented synchronized browsing element is that in-page or in-app co-browsing navigational control can be passed to user 126 (or shared with user 126) at any point within the online journey without requiring that the user 126 give up wholesale control of user device 120.

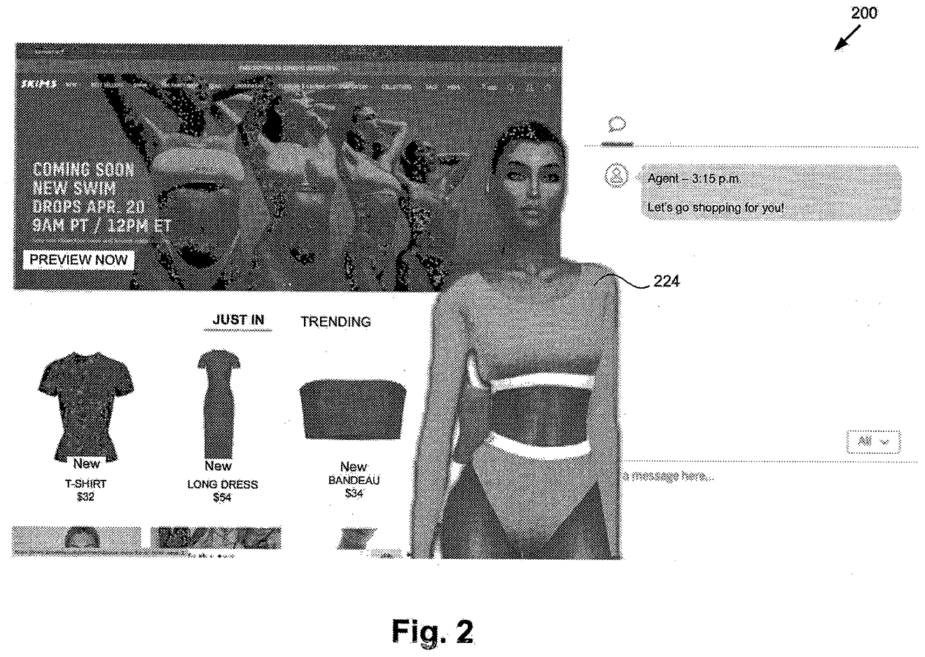

In other implementations, the online user experience between user 126 and AI agent 124 can be fully customized and personalized for each particular user. For example, a “Shop with ‘Celebrity/Influencer’ X” example that includes User Y, User Z and/or multiple other human users may include specific questions, topics and/or personalization options that are based on one or more of a particular online shopper's purchasing and/or browsing histories or habits based on their respective shopping and/or co-browsing histories that may be stored in user profile database 116 (or other elements). FIG. 2 shows exemplary screenshot 200 from such an online co-browsing interaction in system 100, where AI agent 224 has been instantiated and is prepared to interact with one or more human users corresponding to user 126 to facilitate a co-shopping experience, according to one implementation. It is noted that AI agent 224 corresponds in general to AI agent 124 in FIG. 1, and to those corresponding features that may share any of the characteristics attributed to either corresponding feature by the present disclosure.

In other implementations, (a) the AI element can either read and/or comprehend the contents of the relevant webpage to instruct, respond and ask questions of user 126, and/or (b) user 126 can ask questions or give responses that may instruct the AI to match keywords with displayed URLs and/or online browsing interactions for co-browsing purposes. Such concepts can be used to tie in multiple alternative pathways based on specific queries, actions and responses, such as:
In the event that a particular key phrase (or combination of phrases) or action is presented or taken, system 100 shall display the contents of a particular set of URLs and/or online browsing interactions in a predefined order of priority;
In the event that a particular key phrase (or combination of phrases) or action is presented or taken, system 100 allows the integrated AI to select which URL(s(to navigate to and/or which online browsing interactions to perform or render in real time as a response.

The back-end technology can either utilize AI natural language generation or human written script for the determination of the navigational components, or system 100 may use AI agent types of constructs working in combination with one another (AI natural language generation and human scripted). Nevertheless, a fully interactive co-browse layer may be provided that complements the text, image, action or spoken word interactions that take place between user 126 and AI agent 124/224 with this form of highly visual, fully interactive synchronized browsing element.

The following use cases cover three exemplary embodiments of how various implementations of the present application may be used in practice:

Use Case 1: AI agent 124/224 provides fully interactive web content that is tailored for direct and instant interaction (co-browsing) by the user 126.

In conventional solutions for human-agent interactions that relate to assisting an online user who, for example, does not know how to change his or her password, the virtual agent provides the online user with one or more URL links to the relevant web page(s) that may allow the human user to perform this task (e.g., a “Change Password Link” URL). Within this scenario, the burden is then on the human user to perform the required steps on his or her own accord to change the password. This conventional approach is usually challenging to individuals who are less proficient in utilizing modern technology and is only minimally helpful to the user in terms of achieving the ultimate goal of modifying the password in a simple and efficient manner.

According to one implementation of the present application and at any point within the subject interaction after detecting that a password change request is being made based on the text based, spoken, action or other communicative interaction, system 100 initiates a pre-authenticated (logged in) or non-authenticated (not logged in) co-browsing session within the interaction window which provides the relevant start page URL (e.g. the password link page) and/or one that simulates certain online browsing interactions to assist the human user throughout the process of changing the password. Essentially, the system is able to walk the user 126 through the entire process so s/he can fill out highlighted fields and/or perform other online browsing interactions on their own accord. In other words, a predefined URL, stream of URLs or presented online browsing interactions enable user 126 to execute a password change in a manner that is automatically presented to the human user in response to a password change request.

In some implementations, AI agent 124/224 initially assumes the role of host and initial navigational leader of the co-browsing session while user 126 assumes the role of follower who is able to trail the leader's co-browsing path and overall experience with the ability to acquire (or share) in-page navigational control of this particular webpage (specifically) or the entire user experience flow (in general). If user 126 is already logged into a certain web experience or designated web session prior to the initiation of the co-browse session, the user credentials or web session details may be passed into the co-browsing session at startup so that user 126 would not have to re-authenticate (or log in again) once the co-browsing session is initiated. AI agent 124/224 will also have the option of highlighting or pointing out (with its displayed cursor positioning) the “change password” input field (along with any other instructions that may be helpful). AI agent 124/224 may also ask user 126 if s/he would like to assume in-page navigational control of the co-browse session in order to change the password on his or her own accord (e.g., AI agent 124/224 asks: “Would you like to take it from here?”) while optionally noting that input field blocking (i.e. screen redaction) will prevent system 100 from viewing the new or existing password of user 126 as it is entered into or is already visible within the webpage (via sensitive element redaction).

If user 126 selects “yes” to the prompt, user 126 will be able to change the password on the correct page in real-time while input field blocking redacts the password field from the other participants' view for compliance and security reasons. If user 126 selects “no,” user 126 may simply be presented with a URL or link to do it on their own. User 126 can be notified once their password has been successfully reset. It is important to note that user 126 can exit the co-browsing session at any time with the option to assume the presented browsing path on a solitary basis on the last page that was visited within the co-browsing session or on any other predesignated URL that is either selected by system 100, user 126, or AI agent 124/224.

In the above referenced example, common User Question-“I don't know how to change my password” sets the following exemplary steps into motion:
(1) Co-browsing software code 110, executed by hardware processor 104 of system 100, recognizes password change request by user 126.
(2) Co-browsing software code 110, executed by hardware processor 104 of system 100, initiates a co-browsing session with related online browsing interactions on the company's “change password URL” with AI agent 124/224 serving as the initial host and leader with user 126 serving as follower. Thereafter, co-browsing software code 110 recognizes the user's inputting of the request “change my password” and pairs this request with the company's “change my password” URL, series of URLs and/or other online browser interactions in order to present the relevant URL that is eligible for shared browsing in real-time.
(3) AI agent 124/224 may highlight or point out (with its cursor) password change field within a scripted demo format in order to make the process easier for user 126.
(4) AI agent 124/224 may ask the user whether user 126 would like to assume navigational control of the co-browsing session.
(5) If user 126 answers in the affirmative, user 126 can assume in-page navigational control and then change the password successfully while input field blocking and/or other forms of element redaction of sensitive screen elements is active for security and compliance purposes.
(6) AI agent 124/224 may ask if user 126 requires any further assistance.
(7) If user 126 requires further assistance, co-browsing software code 110, executed by hardware processor 104 of system 100, will read or hear the request from user 126 and will pair this keyword or key phrase with a corresponding URL, series of URLs or individual online browsing interactions in order to navigate to and display a new URL within the co-browsing session that will reflect the new user request.
(8) If user 126 does not require further assistance, the co-browsing session may end while leaving user 126 on the last co-browsed URL and/or any other URL that is predefined by system 100 or the web site publisher that is hosting this service.

Use Case 2: AI agent 124/224 provides a scripted tour through cobrowse eligible web content that is tailored for direct and instant interaction and/or cobrowsing by user 126.

In the conventional art for “self-service” remote onboarding interactions, the user is typically presented with a series of linear based static prompts that they are supposed to follow in order to understand how to use or to be onboarded onto the feature sets and user interface components of a particular online product or service.

In one implementation of the present application and at any point within the subject interaction with AI agent 124/224 during an onboarding experience or after detecting that an onboarding, training or assistance session is required based on the text, image, action or spoken word based conversation, AI agent 124/224 would appear and system 100 would start up a co-browsing session that would start on the current page of user 126, or any other appropriate page (e.g., a predefined URL for supporting an onboarding session request).

Within this exemplary interaction, AI agent 124/224 would typically serve as the initial host and leader within the co-browsing session while user 126 assumes the role of follower with the ability to acquire (or share) in-page navigational control. If user 126 is already logged in, the credentials may be passed into the co-browsing session at startup or the same web session may be used or replicated so user 126 would not have to re-authenticate (i.e., to log back in again).

AI agent 124/224 may then highlight each of the relevant functions within the web application (along with any other instructions that may be helpful). After each step, AI agent 124/224 may ask user 126 if they would like to assume in-page navigational control to perform or explore one or more features on their own while noting that input field blocking will prevent system 100 from viewing existing or currently inputted sensitive screen data of user 126 during the co-browsing session.

If user 126 clicks “yes,” user 126 will be able to assume in-page navigational control while screen redaction obfuscates all sensitive elements for security and compliance reasons.

If user 126 clicks “no,” user 126 may simply be presented with a URL link to an asynchronous help support guide.

It is noted that user 126 may exit the co-browsing session at any time while assuming the browsing path on a solitary basis on the last page that was visited within the co-browsing session or any other predefined URL as determined by system 100, user 126, or AI agent 124/224.

In the above referenced example, user's exemplary current page question—“I don't know how to use my Bank's New Dashboard” sets the following exemplary steps into motion:
(1) Co-browsing software code 110, executed by hardware processor 104 of system 100, recognizes the corresponding tutorial request.
(2) Co-browsing software code 110, executed by hardware processor 104 of system 100, initiates a co-browsing session on the present page of user 126 by passing or simulating the web session ID into the cloud browser and/or sharing web browsing interactions in real-time (or via any other method which would achieve the same result).
(3) Agent 124/224 may serve as the initial host and leader and user 126 may serve as the initial follower (or they can share leader control status as it relates to navigational control through the co-browsing session).
(4) AI agent 124/224 may walk user 126 through the tutorial (which includes any appropriate web browsing interactions) with user 126 having the ability to ask questions, perform actions or give responses which would then change the flow and featured content based on keyword, term or recognition and/or in reaction to any path that the user 126 takes within the user journey.
(5) AI agent 124/224 may ask user whether the user 126 would like to assume navigational control of the co-browsing session.
(6) If answered in the affirmative, user 126 would assume navigational control and would then be able to interact with the shared web content in real-time after assuming navigational control.
(7) AI agent 124/224 may ask user 126 whether user 126 needs any additional assistance.
(8) If answered “yes,” the co-browsing session moves onto a new subject with corresponding visuals, URLs and/or online browsing interactions.
(9) If answered “no,” the co-browsing session ends and the user 126 gets directed to the last co-browsed URL or to any other predefined URL as determined by system 100, user 126, or AI agent 124/224.

Use Case 3: AI agent 124/224 provides a scripted shared online shopping experience through cobrowse-ready web content that is tailored for direct and instant interaction by user 126. As with all of the implementations referenced herein, it is noted that this use case may be implemented with or without the presence of an avatar.

### Personal Shopping Example: “Shop Together with Celebrity/Influencer X”

The following two examples describe current conventional solutions for providing a personalized assisted shopping experience to one or more human users:

### EXAMPLE 1

A virtual agent gives an online shopper (user) suggested URL links that correspond to presented user questions and/or online actions; sample queries would include “What jeans are on sale now?” or “I'm looking for a black cocktail dress. Which ones are your favorites?” In the current art, the virtual agent would answer by simply giving the user one or more URLs for them to interact with on a solitary and/or asynchronous basis.

### EXAMPLE 2

In other forms of the current art, the celebrity/influencer shopper would conduct a group shopping session with a large number of users, which features the celebrity/influencer speaking and/or appearing within a video chat window. The celebrity/influencer may also address the entire group of users as s/he shares her screen (using traditional screen broadcasting technology) or relevant URL links to show them online content that s/he likes. The URLs s/he is accessing are available for the users to click on so they can buy those products on an independent and/or asynchronous basis either during or after the shared session.

As it relates to these virtual agent examples, it is noted that neither conventional solution provides a fully interactive synchronized shopping experience for both the moderator/virtual agent and consumer. In the first example, the “personalized shopping” is nothing more than a recommendation engine which provides designated links to the user based on presented questions. In the second example, there is no significant personal interaction occurring amongst the celebrity/influencer virtual agent and the following consumer(s) since all users only have the ability to view the experience rather than to assume (or share) in-page navigational control of the shared browsing path.

In one implementation of the present application and at any point within the user interaction after detecting that a shared shopping co-browsing session is indicated or would be helpful based on the underlying text, image, action or spoken word based conversation, co-browsing software code 110, executed by hardware processor 104 of system 100, would start up a co-browsing session that may start on the current page of user 126 (example: myjeans.com/jeans.html) or any other designated URL. For example, the page could be either (1) a predefined URL that supports a shared shopping session or (2) the current URL of user 126 if the shared shopping co-browse session is to begin on user 126's current page (example: User 126 asks, “What are the best deals on this page?”) AI agent 124/224 would typically serve as the initial host and leader while user 126 would typically assume the role of follower with the ability to acquire (or share) in-page navigational control from or with AI agent 124/224. If user 126 is already logged in, the credentials could be passed into the co-browsing session at startup or the same web session would be used, replicated and/or passed so that user 126 would not have to re-authenticate (or log back in again).

System 100 may then browse through each of the relevant searched items within the website and perform one or more of a series of online browsing interactions within those sites (along with any other instructions that may be helpful). After each step, the AI agent 124/224 may ask user 126 if they would like to assume in-page navigational control of the co-browsing session to perform one or more features or online interactions on their own while noting that input field blocking will prevent the system and/or other users from viewing sensitive screen data or other open windows of user 126.

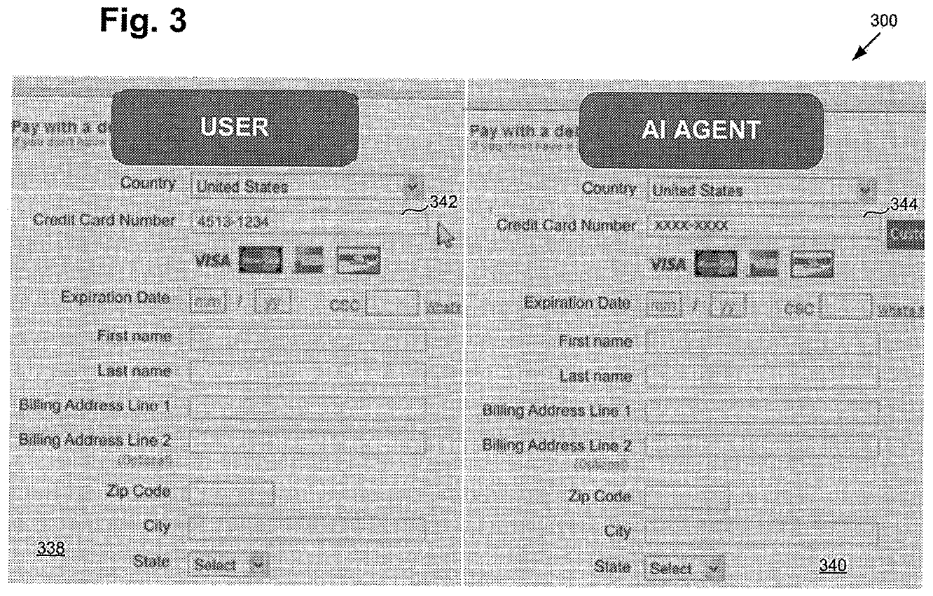

If user 126 clicks “yes,” user 126 will be able to assume in-page navigational control while screen redaction may obfuscate one or more sensitive elements for compliance and security reasons. Referring to FIG. 3, diagram 300 provides a visual example of the use of element redaction technology to protect sensitive customer information during a co-browsing session with AI agent 124/224. FIG. 3 shows user 126 facing unredacted co-browsing page 338 while AI agent faces redacted co-browsing page 340. It is noted that user 126 facing unredacted co-browsing page 338 corresponds in general to unredacted co-browsing page 138 in FIG. 1, and those corresponding features may share any of the characteristics attributed to either corresponding feature by the present disclosure.

Referring to FIGS. 1, 2 and 3 in combination, user facing co-browsing page 338 includes user credit card number 342 of user 126, which is necessary to complete a transaction. However and while AI agent 124/224 is able to synchronously and contemporaneously browse (i.e., co-browse with user 126), the user credit card number is replaced with redaction element 344 (or is simply left blank) on AI agent facing redacted co-browsing page 340.

If user 126 clicks “no,” user 126 may simply be presented with the links that were shared up to this point within the progression of the co-browsing session.

It is noted that user 126 is able to exit the co-browsing session at any time while being able to independently resume the browsing path on the last page that was visited within or before the co-browsing session or any other URL that is determined by system 100, user 126, or AI agent 124/224.

“Celebrity/Influencer X's” online interactions with one or more users within an exemplary synchronized shopping experience sets the following exemplary steps into motion:
(1) “Celebrity/Influencer X” AI agent 124/224 is typically the initial host and leader of the cobrowse session.
(2) User 126 is typically the follower with the ability to request solo and/or shared in-page navigational control of the cobrowse session (where the last online browsing interactions that are performed by any of the leading participants will necessarily reflect the navigational course of the shared online browsing journey).
(3) Celebrity/Influencer X AI agent 124/224 may walk user 126 through options based on one or more requests, such as queries or actions by user 126, or other inputs (e.g. “What are your favorite jeans this year?”, “Can you show me the new fall collection?” or “Which virtual door should I walk through to get the result I'm seeking?”).
(4) Celebrity/Influencer X AI agent 124/224 may walk user 126 through a prescribed URL and/or corresponding online browsing interaction flow based on a recognized series of single or keyword combinations (e.g. if the detected phrase is “Celebrity/Influencer X's favorite jeans,” the start URL may be hm.com/favejeans.html) or individual actions by the user(s) within their journey with the ability to ask questions or receive responses from user 126 that may change the URLs and/or online browsing interactions that are executed based on keyword recognition or individual user actions.
(5) At any point within the session, Celebrity/Influencer X AI agent 124/224 may ask user 126 whether user 126 would like to assume navigational control of the co-browsing session.
(6) User 126 may thereafter assume navigational control of the co-browsing session (or may already have control if control is automatically shared at the beginning of the shared interaction) and may then interact with the featured shopping components by performing exemplary online browsing interactions such as scrolling, clicking links/images, filling out forms and/or navigating through a 3D virtual environment while walking through to the end of the transaction.
(7) Celebrity/Influencer X AI agent 124/224 may ask if the user requires additional assistance.
(8) If the response is “yes,” the co-browsing session moves on to a new subject with a corresponding set of new URLs within a new online experience journey.
(9) If the response is “no,” the co-browsing session ends and user 126 gets directed to the last co-browsed URL or to any other URI that is determined by system 100, user 126, and/or AI agent 124/224.

In one implementation of the present application that is related to scripted and/or AI machine learning interactions amongst humans and agents, some interactions are scripted in a manner that walks user 126 right through the exemplary password changing experience referenced above while giving user 126 in-page navigational control of the co-browsing session so that user 126 can do it on their own.

Other exemplary interactions may involve having AI agent 124/224 make suggestions based upon the actions of the user(s) and/or requests that are presented within the underlying interaction (either within a single browser tab or window and/or multiple cobrowse tabs where the users can toggle back and forth within multiple tabs as they would if they were using a modern browser such as Google Chrome®, Microsoft Edge® or Mozilla Firefox® on a solitary basis).

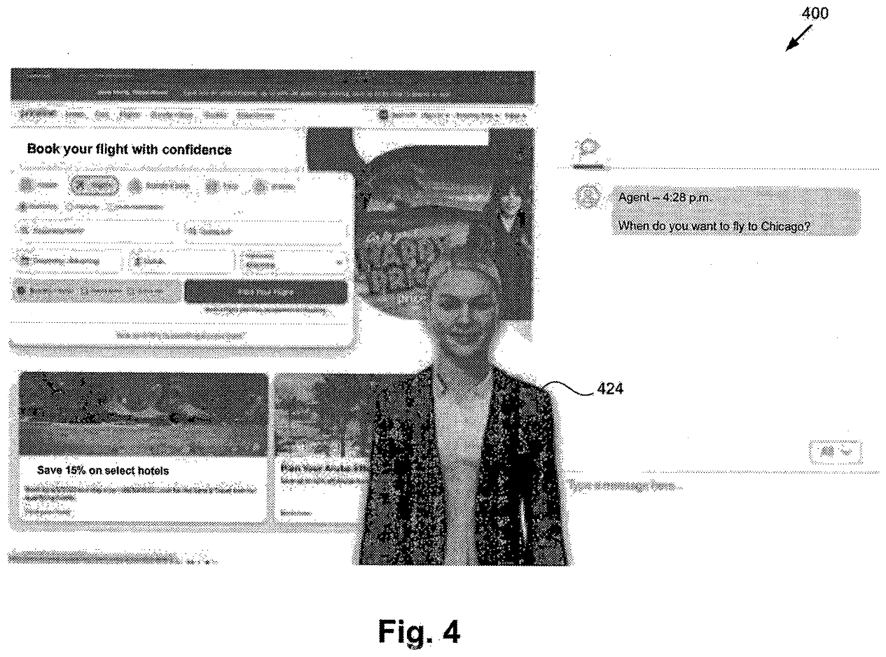

Referring to FIG. 4, this image shows exemplary screenshot 400 from a co-browsing session, according to another implementation, in which a user corresponding to user 126 is provided with an opportunity to interact with AI agent 424 named Kayla (hereinafter also “AI agent Kayla”) to arrange air travel. The following would serve as sample dialogue:
User: Let's plan a trip.
AI Agent Kayla: Shall we go to travel services vendor A, B, or C?
User: Let's go to vendor B.
System 100: Co-browsing session is initiated on vendorb.com.
AI agent Kayla: Where would you like to go?
User: Chicago, Illinois.
AI Agent Kayla: Round trip or One Way?
User: Kayla, can I take control?
System 100: After receiving an affirmative response from the User, system 100 passes navigational control of the co-browsing session to the user.

It is noted that AI agent 424 corresponds in general to AI agent 124/224 in FIGS. 1 and 2. Consequently, AI agent 424 may share any of the characteristics attributed to AI agent 124/224 by the present disclosure, and vice versa. It is further noted that the manner in which a user that corresponds to user 126 may initiate and/or join an online sharing experience is disclosed in detail within the following patents and patent applications:
(1) U.S. Pat. No. 8,527,591, titled “Method And Apparatus For The Implementation Of A Real-time, Sharable Browsing Experience On A Guest Device,” and issued on Sep. 3, 2013, which is hereby incorporated fully by reference into the present application.
(2) U.S. Pat. No. 9,171,087, titled “Method And Apparatus For The Implementation Of A Real-time, Sharable Browsing Experience On A Host Device,” and issued on Oct. 27, 2015, which is hereby incorporated fully by reference into the present application.
(3) U.S. Pat. No. 9,185,145, titled “Method And Apparatus For The Implementation Of A Real-time, Sharable Browsing Experience On A Guest Device,” and issued on Nov. 10, 2015, which is hereby incorporated fully by reference into the present application.
(4) U.S. Pat. No. 9,483,448, titled “Method And Apparatus For The Implementation Of A Real-time, Sharable Browsing Experience On A Host Device,” and issued on Nov. 1, 2016, which is hereby incorporated fully by reference into the present application;
(5) U.S. Pat. No. 9,489,353, titled “Method And Apparatus For The Implementation Of A Real-time, Sharable Browsing Experience On A Host Device,” and issued on Nov. 8, 2016, which is hereby incorporated fully by reference into the present application;
(6) U.S. patent application Ser. No. 18/225,982, titled “Content and Device Agnostic Online Experience Sharing with In-Page Control Passing,” filed Jul. 25, 2023, which is hereby incorporated fully by reference into the present application; and
(7) U.S. patent application Ser. No. 18/370,331, titled “Content and Device Agnostic Online Experience Sharing with In-Page Control Passing,” filed Sep. 19, 2023, which is hereby incorporated fully by reference into the present application.

It is also noted that the manual administration of system 100 and/or the results or responses received from NLG 134, such as exemplary sources like ChatGPT® and Google® Gemini, can be used to receive and execute specific URLs, instructions, scripts, online browsing interactions and/or other elements in the co-browsing session. These forms of data may direct the nature of the displayed content, scripted online browsing interactions and other actions that are set to appear in the co-browse window as a complement to the results and/or responses received from the relevant AI engines. For example and if the query or request by user 126 is “What are healthiest types of lip gloss on the market?”, system 100 may direct that the results generated in response to the query or request would be complemented by a co-browsing window that has been directed to go to one or more URLs (e.g., makeup shopping sites) and/or to thereafter perform certain scripted or AI-driven online browsing interactions. As described above, user 126 would be able to assume (or share) navigational control with AI agent 124/224/424 so that user 126 can: (1) browse those specific URLs independently; (2) view and/or interact with exemplary online browsing interactions such as page scrolling, highlighting of certain page elements, form filling and video playback; (3) learn more about the underlying product, service or subject; and/or (4) consummate the underlying transaction in real-time within a secure framework.

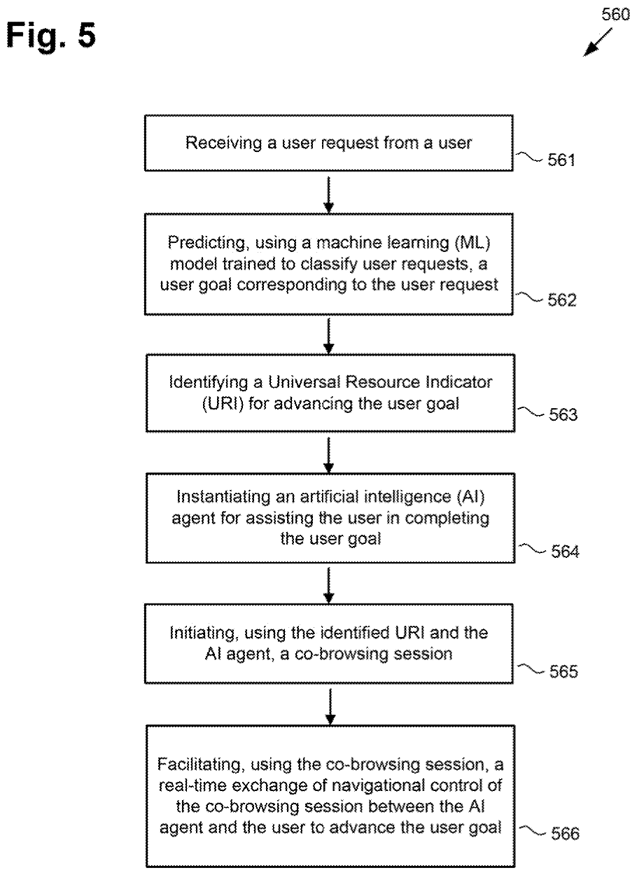

The functionality of system 100 including co-browsing software code 110 and ML model 128 that is trained to classify user requests based either on user communications or user originated online action will be further described by reference to FIG. 5. FIG. 5 shows flowchart 560 presenting an exemplary method for use by a system to provide co-browsing for interactions amongst AI agents and humans, according to one implementation. With respect to the method outlined in FIG. 5, it is noted that certain details and features have been left out of flowchart 560 in order not to obscure the discussion of the inventive features in the present application.

Referring to FIG. 5 and with further reference to FIG. 1, flowchart 560 includes recognition of a user originated online action and/or receiving user request 136 from user 126 (action 561). User request 136 may include one or more types of speech by user 126 (i.e., human speech or an exemplary manual input to user system 120 by user 126 such as a keyboard, mouse, trackpad, or touchscreen input to user system 120). User request 136 may take the form of a query, such as a question or a statement. By way of example and in use cases in which user 126 desires to change their password, user request 136 may include the question: “How do I change my password?” Alternatively and in that use case, user request may include the statement: “I don't know how to change my password.” User request 136 may be received, in action 561, by co-browsing software code 110, which is executed by hardware processor 104 of system 100. As shown in FIG. 1, user request 136 may be received from user 126 via communication network 130 and network communication links 132.

Continuing to refer to FIGS. 1 and 5 in combination, flowchart 560 further includes predicting, using ML model 128, a user goal corresponding to user request 136 (action 562). As noted above, ML model 128 is trained to classify user requests and/or to comprehend specific user actions. In some implementations, ML model 128 may be or include an NN, such as a deep NN. ML Training data for ML model 128 may include a variety of types of requests or actions, thereby enabling ML model 128 to distinguish among requests for information, requests for assistance in completing a task, or requests for the provisioning of a service such as a guided shopping or travel planning experience. As described by the specific use cases discussed above, the user goal corresponding to user request 136 may include changing a password of user 126, or other exemplary use cases like shopping or travel planning in a fully synchronized fashion. Predicting the user goal corresponding to user request 136 as it pertains to action 562 may be performed by co-browsing software code 110, which is executed by hardware processor 104 of system 100, while using ML model 128.

Continuing to refer to FIGS. 1 and 5 in combination, flowchart 560 further includes, identifying one or a series of Uniform Resource Locators (URLs) for advancing the user goal (action 563). In use cases in which the user goal is a password change, action 563 includes identifying the URL and/or associated online browsing interactions within a webpage for enabling such a password change. Analogously and in use cases in which the user goal is shopping or travel planning with other remote users in real time, action 563 includes identifying the URL or series of URLs (and/or associated online browsing interactions) that support shopping or travel planning, respectively. Action 563 may be performed by co-browsing software code 110, which is executed by hardware processor 104 of system 100.

Referring to FIG. 5 in combination with FIGS. 1, 2 and 4, flowchart 560 further includes instantiating AI agent 124/224/424 for assisting user 126 in completing the user goal (action 564). In some implementations and as shown in FIG. 1, system 100 may include AI agent database 112 including multiple AI personas 114a and 114b. Each of AI personas 114a and 114b may correspond to a different gender, personality type, area of expertise, or any combination thereof of an AI agent. In some implementations, AI agent database 112 may include duplicate AI personas having substantially the same personality and expertise but differing only by gender. That is to say that in some implementations, AI persona 114a may depict a friendly and extroverted male AI travel agent persona, while AI persona 114b may depict a friendly and extroverted female AI travel agent persona. Alternatively, AI persona 114a may depict one of a male or female AI agent having exemplary expertise in one of password changes, shopping, or travel planning, while AI persona 114b may depict one of a male or female AI agent having expertise within realms other than exemplary password changes, shopping, or travel planning.

In implementations in which system 100 includes AI agent database 112, action 564 may include selecting, based on the user goal, one of AI personas 114a or 114b for AI agent 124/224/424. Moreover and in those implementations, AI agent 124/224/424 may be instantiated using the selected one of AI personas 114a or 114b.

In some implementations and as shown in FIG. 1, system 100 may further include user profile database 116 which include co-browsing histories 118a, 118b and 118c. As noted above, each of co-browsing histories 118a, 118b and 118c may correspond to an interaction history of a user, such as user 126, with one or more AI agents, such as AI agent 124/224/424. Co-browsing histories 118a, 118b and 118c may provide insight into what type of information or assistance user 126 may be requesting, as well as which AI persona stored in AI agent database 112 is likely to be most relevant to user request 136.

Within implementations in which system 100 includes user profile database 116, action 564 may also include obtaining the co-browsing history for user 126 from user profile database 116. Moreover and in those implementations, one of the AI personas 114a or 114b for AI agent 124/224/424 may be selected further based on the co-browsing history of user 126. The instantiation of AI agent 124/224/424 for assisting user 126 in completing the user goal corresponding to user request 136, in action 564, may be performed by co-browsing software code 110, which is executed by hardware processor 104 of system 100.

Continuing to refer to FIGS. 1, 2, 4 and 5 in combination, flowchart 560 further includes initiating a co-browsing session (action 565), using the URL or URLs identified in action 563 and AI agent 124/224/424 instantiated in action 564. In some implementations, the co-browsing session initiated in action 565 may include interactions by AI agent 124/224/424 with user 126 based on scripted dialogue for AI agent 124/224/424. That is to say and depending upon the gender, personality type and expertise of a particular AI agent persona, AI personas 114a and 114b may include one or more scripts of predetermined dialogue phrases, as well as rules for selecting among and combining those predetermined dialogue phrases in response to user request 136, one or more other inputs from user 126, or the user goal predicted in action 562.

Alternatively or in addition for some implementations, the co-browsing session initiated in action 565 may include interactions by AI agent 124/224/424 with user 126 based on dialogue generated dynamically for AI agent 124/224/424. For example, system 100 may utilize NLG 134, which as noted above may be or include a large-language model, to dynamically generate dialogue for AI agent 124/224/424 based on one or more of user request 136, one or more other inputs by user 126, or the user goal predicted in action 562.

Thus and in various implementations, the co-browsing session initiated in action 565 may include interactions by AI agent 124/224/424 with user 126 based on scripted dialogue for AI agent 124/224/424, based on dialogue that is generated dynamically for AI agent 124/224/424, based on performed actions of user 126 or based on any combination thereof.

It is noted by further reference to FIG. 3 as discussed above, the co-browsing session initiated in action 565 may also include concurrently providing unredacted user facing co-browsing page 138/338 to user 126 and AI agent facing redacted co-browsing page 340 for use by the AI agent. In this embodiment, unredacted user facing co-browsing page 138/338 is at least partially inaccessible or invisible to AI agent 124/224/424 which protects sensitive information of user 126 such as credit card numbers, social security numbers, personally identifiable information (PII) and the like. The initiation of the co-browsing session in action 565 may be performed by co-browsing software code 110, which is executed by hardware processor 104 of system 100, and which may include using one or both of AI agent database 112 and NLG 134.

Continuing to refer to FIGS. 1, 2, 4 and 5 in combination, flowchart 560 further includes facilitating, using the co-browsing session initiated in action 565, a real-time exchange, such as passing or sharing, of navigational control of the co-browsing session between AI agent 124/224/424 and user 126 to advance the user goal (action 566). As defined in the present application, it is noted that the expression “real-time” refers to a time interval which enables an exemplary interaction, such as a dialogue response or exchange of navigational control during a co-browsing session, to occur without an unnatural seeming delay between a request or other input by user 126, and a responsive acknowledgement or action by AI agent 124/224/424. By way of example, “real-time” may refer to an AI agent response time of some fraction of a second. The real-time exchange of navigational control of the co-browsing session initiated in action 565 may be performed by co-browsing software code 110, in action 566, which is executed by hardware processor 104 of system 100.

Referring to FIGS. 1 and 5 in combination and with respect to the method outlined by flowchart 560, it is also noted that the actions described by reference to that method for use by a system to provide co-browsing for interactions amongst AI agents and humans may be performed as an automated process from which human participation, other than the interaction by user 126 with AI agent 124/224/424, may be omitted.

Thus, the present application discloses a system that combines synchronized browsing and/or co-browsing functionality with scripted, machine learning and/or AI technology. This application presents a parallel co-browse system that synchronously simulates the underlying exchanges that are occurring amongst one or more AI agents and one or more human users within a highly visual and fully interactive multi-user system that provides an instantly actionable framework for online interaction, synchronized browsing and/or co-browsing. From the above description, it is manifest that various techniques can be used for implementing the concepts described in the present application without departing from the scope of those concepts. Moreover and while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

1-20. (canceled)

21: A system for providing a simulated browsing session, the system comprising:
a cloud browser;
a machine learning (ML) model trained to classify requests;
an application programming interface (API); and
a processor configured to:
instantiate a first artificial intelligence (AI) controlled agent;
receive a request from a human user device or a second AI controlled agent;
predict, using the trained ML model, a goal corresponding to the request;
identify a Uniform Resource Locator (URL) for advancing the goal;
initiate, using the first AI controlled agent and the identified URL, the simulated browsing session;
autonomously determine, using the first AI controlled agent, an online action for advancing the goal;
select, using the first AI controlled agent based on the online action, one or both of the cloud browser or the API for executing the online action;
execute the online action, using the one or both of the cloud browser or the API selected for executing the online action, to generate a result for advancing the goal; and
communicate, to at least one of the human user device or the second AI controlled agent, the result for advancing the goal.

22: The system of claim 21, wherein the processor is further configured to:
autonomously determine, using the first AI controlled agent, one or more subsequent online actions for advancing the goal, using the first AI controlled agent based on at least one of (i) the request, (ii) frame data generated as the result of executing the online action, or (iii) raw data generated as the result of executing the online action;
select, using the first AI controlled agent based on the one or more subsequent online actions, one or both of the cloud browser or the API for executing at least one of the one or more subsequent online actions;
execute the at least one of the one or more of the subsequent online actions, using the one or both of the cloud browser or the API selected for executing the one or more subsequent online actions, to generate another result for advancing the goal; and
communicate, to at least one of the human user device or the second AI controlled agent, the another result for advancing the goal.

23: The system of claim 21, wherein the simulated browsing session includes concurrently providing a first simulated browsing page to the human user device or the second AI controlled agent, and a second simulated browsing page for use by the first AI controlled agent, wherein the first simulated browsing page is different than the second simulated browsing page, and one or more differences include one or more portions of the second simulated browsing page being inaccessible, redacted or invisible to the first AI controlled agent.

24: The system of claim 21, wherein the simulated browsing session comprises interactions by the first AI controlled agent with the human user device or the second AI controlled agent based on scripted dialogue for the first AI controlled agent.

25: The system of claim 21, wherein the simulated browsing session comprises interactions by the first AI controlled agent with the human user device or the second AI controlled agent based on dialogue generated dynamically for the first AI controlled agent.

26: The system of claim 21, further comprising:
an AI agent database storing at least one of a plurality of AI agent personas or a plurality of personalization elements;
wherein the processor is further configured to:
select, based on the goal, one of the at least one of the plurality of AI agent personas or the plurality of personalization elements for the first AI controlled agent;
wherein the first AI controlled agent is instantiated using the selected one of the at least one of the plurality of AI personas or the plurality of personalization elements.

27: The system of claim 26, further comprising:
a user profile database including a simulated browsing history of the human user device or the second AI controlled agent;
wherein the processor is further configured to:
obtain the simulated browsing history from the user profile database; and
wherein the one of the plurality of AI personas for the first AI controlled agent is selected further based on the simulated browsing history.

28: The system of claim 21, wherein the goal comprises one of changing a password, shopping, travel planning, online assistance, or online collaboration.

29: The system of claim 21, wherein the system is a server remotely located from and configured to communicate with the human user device via a network, and wherein the system supports interaction by the human user device with the system using one or more of an online application or an online device.

30: The system of claim 29, wherein the one or more of the online application or the online device comprises at least one of a web browser, a computer application, a mobile application, a web-enabled device, a virtual reality hardware or software, or an augmented reality hardware or software.

31: A method for use by a system for providing a simulated browsing session, the system including a cloud browser, a machine learning (ML) model trained to classify requests, and an application programming interface (API), the method comprising:
instantiating a first artificial intelligence (AI) controlled agent;
receiving a request from a human user device or a second AI controlled agent;
predicting, using the trained ML model, a goal corresponding to the request;
identifying a Uniform Resource Locator (URL) for advancing the goal;
initiating, using the first AI controlled agent and the identified URL, the simulated browsing session;
autonomously determining, using the first AI controlled agent, an online action for advancing the goal;
selecting, using the first AI controlled agent based on the online action, one or both of the cloud browser or the API for executing the online action;
executing the online action, using the one or both of the cloud browser or the API selected for executing the online action, to generate a result for advancing the goal; and
communicating, to at least one of the human user device or the second AI controlled agent, the result for advancing the goal.

32: The method of claim 31, further comprising:
autonomously determining, using the AI controlled agent, one or more subsequent online actions for advancing the goal, using the first AI controlled agent based on at least one of (i) the request, (ii) frame data generated as the result of executing the online action, or (iii) raw data generated as the result of executing the online action;
selecting, using the AI controlled agent based on the one or more subsequent online actions, one or both of the cloud browser or the API for executing at least one of the one or more subsequent online actions;
executing the at least one of the one or more of the subsequent online actions, using the one or both of the cloud browser or the API selected for executing the one or more subsequent online actions, to generate another result for advancing the goal; and
communicating, to at least one of the human user device or the second AI controlled agent, the another result for advancing the goal.

33: The method of claim 31, wherein the simulated browsing session includes concurrently providing a first simulated browsing page to the human user device or the second AI controlled agent, and a second simulated browsing page for use by the first AI controlled agent, wherein the first simulated browsing page is different than the second simulated browsing page, and one or more differences include one or more portions of the second simulated browsing page being inaccessible, redacted or invisible to the first AI controlled agent.

34: The method of claim 31, wherein the simulated browsing session comprises interactions by the first AI controlled agent with the human user device or the second AI controlled agent based on scripted dialogue for the first AI controlled agent.

35: The method of claim 31, wherein the simulated browsing session comprises interactions by the first AI controlled agent with the human user device or the second AI controlled agent based on dialogue generated dynamically for the first AI controlled agent.

36: The method of claim 31, further comprising:
selecting, based on the goal, one of at least one of a plurality of AI agent personas or a plurality of personalization elements for the first AI controlled agent;
wherein the first AI controlled agent is instantiated using the selected one of the at least one of the plurality of AI personas or the plurality of personalization elements.

37: The method of claim 36, further comprising:
obtaining a simulated browsing history of the human user device or the second AI controlled agent;
wherein the one of the plurality of AI personas for the first AI controlled agent is selected further based on the simulated browsing history.

38: The method of claim 31, wherein the goal comprises one of changing a password, shopping, travel planning, online assistance, or online collaboration.

39: The method of claim 31, wherein the system is a server remotely located from and configured to communicate with the human user device via a network, and wherein the system supports interaction by the human user device with the system using one or more of an online application or an online device.

40: The method of claim 39, wherein the one or more of the online application or the online device comprises at least one of a web browser, a computer application, a mobile application, a web-enabled device, a virtual reality hardware or software, or an augmented reality hardware or software.
